(19) United States
(12) Patent Application Publication
(10) Pub. No.: US 2018/0102847 A1
(43) Pub. Date: Apr. 12, 2018

(54) PHOTONIC BEAM FORMING NETWORK CHIP BASED ON SILICON SEMICONDUCTOR

(71) Applicant: Korea Advanced Institute of Science and Technology, Daejeon (KR)

(72) Inventors: Jong-Hun KIM, Daejeon (KR); Young-Su KIM, Daejeon (KR); Dong Eun YOO, Daejeon (KR); Dongwook LEE, Daejeon (KR); Ki-Nam KIM, Daejeon (KR); Hae Chul HWANG, Daejeon (KR)

(21) Appl. No.: 15/336,538

(22) Filed: Oct. 27, 2016

(30) Foreign Application Priority Data
Oct. 11, 2016 (KR) 10-2016-0131381

(51) Int. Cl. H04B 10/2575; H04B 10/516; H04B 10/50; G02F 1/225; G02B 6/28; G02F 1/025; G02F 1/01

(52) U.S. Cl. CPC H04B 10/25752; H04B 10/516; H04B 10/501; G02F 2001/212; G02B 6/2861; G02F 1/025; G02F 1/0147; G02F 1/2255

(57) ABSTRACT

Disclosed is a photonic beam forming network chip using silicon semiconductor based monolithic integration for fabrication and using true time delay for signal processing of a phased array antenna, including at least one power splitter a plurality of Mach-Zehnder modulators, a plurality of true time delay devices, a photonic detector, and a photonic waveguide configured to respectively connect the at least one power splitter, the plurality of Mach-Zehnder modulators, the plurality of true time delay devices, and the photonic detector.

### CROSS-REFERENCE TO RELATED APPLICATIONS

This application claims priority under 35 U.S.C. § 119 to Korean Patent Application No. 10-2016-0131381, filed Oct. 11, 2016, which is incorporated by reference in its entirety.

### BACKGROUND OF THE INVENTION

### Field of the Invention

Embodiments of the inventive concept described herein relate to a Photonic Beam Forming Network (PBFN) chip based on silicon semiconductor, and more particularly, relate to beam steering technology for processing an RF signal, which is received or transmitted through a phased array antenna, based on optical True Time Delay (TTD).

### Description of the Related Technology

Embodiments of the inventive concept described herein relate to a Photonic Beam Forming Network (PBFN) chip based on silicon semiconductor, and more particularly, relate to beam steering technology for processing an RF signal, which is received or transmitted through a phased array antenna, based on optical True Time Delay (TTD).

A traditional Beam Forming Network (BFN) has been formed based on a Monolithic Microwave Integrated Circuit (MMIC).

Such a BFN has disadvantages that limit its commercialization because of a large chip size, increase the number of phased array antennas, and widen a required frequency bandwidth, causing much power consumption and signal interference at phase delay portions to meet its functional limitations.

For that reason, SATARAX Company of Holland has proposed an Optical Beam Forming Network (OBFN) including True Time Delay (TTD) based on Si3N4 photonic waveguide.

However, the OBFN formed with a Mach-Zehnder Modulator (MZM) based on InP in structure may induce a photonic coupling effect with a TTD device based on Si3N4 photonic waveguide.

Therefore, there is required to prevent such a photonic coupling effect between a MZM and a TTD formed based on a two-different type substrate.

### SUMMARY

Embodiments of the inventive concept provide a photonic beam forming network chip suitable for preventing a photonic coupling effect between an InP-compound semiconductor based MZM and an Si3N4 photonic waveguide based TTD which is equipped in an existing OBFN, using silicon photonics technology.

In detail, embodiments of the inventive concepts provide a photonic beam forming network chip connected based on a photonic waveguide without any coupling effect between a plurality of MZM and a plurality of TTD devices by fabricating at least one power splitter to split optical power, which is generated from one photonic source, into equivalents, a plurality of MZM to change a plurality of RF signals into photonic signals of a plurality of channels by using the at least one power splitter, and a plurality of TTD devices to compensate or adjust time delays for a plurality of antennas to the photonic signals of the plurality of channels based on a ring resonator, on a single chip.

Additionally, embodiments of the inventive concept provide a photonic beam forming network chip configuring a photonic waveguide, which has a photonic waveguide loss value equal to or lower than a specific reference value, to minimize photonic loss differences between photonic signals of a plurality of channels that are changed from a plurality of RF signals.

Additionally, embodiments of the inventive concept provide a photonic beam forming network package and a photonic beam forming network system that are based on a photonic beam forming network chip.

According to an aspect of an embodiment, a photonic beam forming network chip using silicon semiconductor based monolithic integration for fabrication and using true time delay for signal processing of a phased array antenna includes at least one power splitter configured to split optical power, which is generated from a photonic source, in equivalents, a plurality of Mach-Zehnder modulators configured to change a plurality of RF signals, which are transmitted to or received from a plurality of antennas, into photonic signals of a plurality of channels by using the at least one power splitter, a plurality of true time delay devices configured to compensate or adjust time delays for the plurality of antennas to the photonic signals of the plurality of channels, a photonic detector configured to change a single photonic signal that is formed by coupling the photonic signals of the plurality of channels, or the photonic signals of the plurality of channels, into an RF signal, and a photonic waveguide configured to respectively connect the at least one power splitter, the plurality of Mach-Zehnder modulators, the plurality of true time delay devices, and the photonic detector.

The number of the plurality of Mach-Zehnder modulators may be determined based on the number of the plurality of antennas.

Each of the plurality of true time delay devices may be formed by providing a ring resonator in the photonic waveguide and may be configured to compensate or adjust time delays for the plurality of antennas in accordance with an operation of the ring resonator.

The photonic waveguide may be configured to have a photonic waveguide loss value equal to or lower than a reference value to minimize photonic loss differences between the photonic signals of the plurality of channels.

The photonic beam forming network chip may further include a plurality of photonic attenuators configured to tune photonic loss of the plurality of true time delay devices in a range.

Each of the plurality of photonic attenuators may be formed by attaching a p-i-n diode to the photonic waveguide.

The photonic beam forming network chip may further include a plurality of phase tuners configured to synchronize phase change through free carrier injection in the plurality of photonic attenuators.

Each of the plurality of phase tuners may be configured by attaching a metal heater to the photonic waveguide.

The photonic waveguide included in each of the plurality of Mach-Zehnder modulators and the plurality of the true time delay devices may include a metal heater configured to adjust a center operating wavelength through a thermo-optical effect.

The photonic beam forming network may further include a plurality of hybrid photonic amplifiers configured to amplify the photonic signals of the plurality of channels.

The photonic beam forming network chip may further include at least one power combiner configured to couple the photonic signals of the plurality of channels.

According to another aspect of an embodiment, a photonic beam forming network package using silicon semiconductor based monolithic integration for fabrication and using true time delay for signal processing of a phased array antenna includes a photonic beam forming network chip, and a transmission module and a reception module that control the photonic beam forming network chip, wherein the photonic beam forming network chip includes at least one power splitter configured to split optical power, which is generated from a photonic source, in equivalents, a plurality of Mach-Zehnder modulators configured to change a plurality of RF signals, which are transmitted to or received from a plurality of antennas, into photonic signals of a plurality of channels by using the at least one power splitter, a plurality of true time delay devices configured to compensate or adjust time delays for the plurality of antennas to the photonic signals of the plurality of channels, a photonic detector configured to change a single photonic signal that is formed by coupling the photonic signals of the plurality of channels, or the photonic signals of the plurality of channels, into an RF signal, and a photonic waveguide configured to respectively connect the at least one power splitter, the plurality of Mach-Zehnder modulators, the plurality of true time delay devices, and the photonic detector.

According to another aspect of an embodiment, a photonic beam forming network system using silicon semiconductor based monolithic integration for fabrication and using true time delay for signal processing of a phased array antenna includes a photonic beam forming network package, and a field programmable gate array configured to control the photonic beam forming network package, wherein the photonic beam forming network package includes at least one power splitter configured to split optical power, which is generated from a photonic source, in equivalents, a plurality of Mach-Zehnder modulators configured to change a plurality of RF signals, which are transmitted to or received from a plurality of antennas, into photonic signals of a plurality of channels by using the at least one power splitter, a plurality of true time delay devices configured to compensate or adjust time delays for the plurality of antennas to the photonic signals of the plurality of channels, a photonic detector configured to change a single photonic signal that is formed by coupling the photonic signals of the plurality of channels, or the photonic signals of the plurality of channels, into an RF signal, a photonic waveguide configured to respectively connect the at least one power splitter, the plurality of Mach-Zehnder modulators, the plurality of true time delay devices, and the photonic detector, and a transmission module and a reception module that control the plurality of Mach-Zehnder modulators.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a diagram illustrating a photonic beam forming network chip according to an embodiment;

FIG. 2 is a diagram illustrating a photonic beam forming network chip according to another embodiment;

FIG. 3 is a diagram illustrating a photonic beam forming network package according to an embodiment; and

FIG. 4 is a diagram illustrating a photonic beam forming network system according to an embodiment.

### DETAILED DESCRIPTION OF CERTAIN INVENTIVE EMBODIMENTS

Hereafter, embodiments of the inventive concept will be described in conjunction with the accompanying figures. The inventive concept however may not be restrictive to embodiments as proposed below. Like reference numerals denote like elements throughout the accompanying figures.

Additionally, terms used in the specification are adopted to show pertinent expressions for preferred embodiments and may be variable in accordance with intentions of the operator or usual practices of the technical field including the inventive concept. Accordingly, these terms should be construed in definitions based on contents arranged throughout the overall description of the specification.

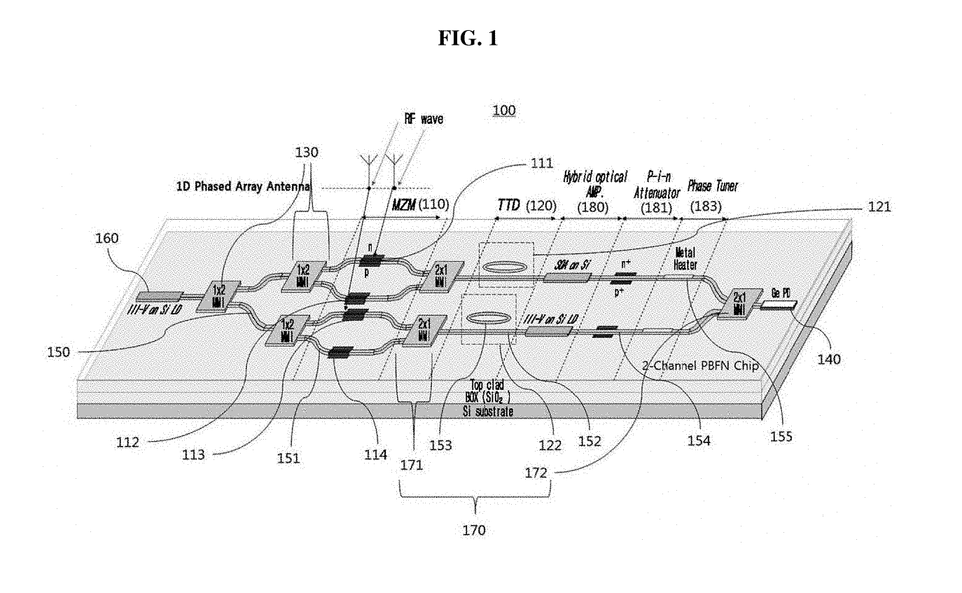

FIG. 1 is a diagram illustrating a photonic beam forming network chip according to an embodiment.

Referring to FIG. 1, a photonic beam forming network chip 100 according to an embodiment may be fabricated to use a practical time delay for processing a signal of a phased array antenna by silicon monolithic integration based on a silicon semiconductor.

The photonic beam forming network chip 100 may include a plurality of Mach-Zehnder Modulators (MZM) 110, a plurality of True Time Delay (TTD) devices 120, at least one power splitter 130, and a photonic detector 140. The plurality of MZM 110, the plurality of TTD devices 120, the at least one power splitter 140, and a photonic detector 140 may be respectively connected with a photonic waveguide 150.

The plurality of MZM 110 may be respectively connected with a plurality of antennas to change a plurality of RF signals, which are received from the plurality of antennas, into photonic signals of a plurality of RF signals. During this, each of the plurality of MZM 110 may be formed by attaching a p-n diode to the photonic wave guide 151 based on a Si-CMOS process.

Especially, the plurality of MZM 110 may use the at least one power splitter 130, which will be described later, to channel a plurality of RF signals into photonic signals of a plurality of channels.

For example, responding to that each optical power split from optical power introduced from a photonic source 160 is turned on or off and a reverse voltage is applied to a p-n diode, each of the plurality of MZM 110 may change one of a plurality of RF signals into a photonic signals of one of a plurality of channels by varying a refractive index of the photonic waveguide 151 through a Free Carrier Plasma Dispersion (FCPD) effect in the mechanism of adjusting a depletion region.

In other words, by changing an effective refractive index of the photonic waveguide 151 based on an electro-optical effect, the plurality of MZM may perform an operation for changing a plurality of RF signals into the photonic signals of the plurality of channels in a high speed equal to or higher than several Gbps.

During this, the number of the plurality of MZM 110 may be set based on the number of the plurality of antennas.

The plurality of TTD devices 120 may compensate or adjust time delays for the plurality of antennas to the photonic signals of the plurality of channels. Especially, since the plurality of TTD devices 120 are respectively formed with a ring resonator 153 (e.g., silicon-based ring resonator) which is provided to the photonic waveguide 152, it may be permissible to compensate or adjust time delays for the plurality of antennas.

For example, since each ring resonator 153 of the plurality of TTD devices 120 may adjust photonic coupling or center operating wavelength of the photonic waveguide 152, it may be permissible to compensate or adjust time delay for the plurality of antennas to a photonic signal (one of the photonic signals of the plurality of channels) that is progressing along the photonic waveguide 152.

In other words, by adjusting sizes and the number of the ring resonators 153 included respectively in the plurality of TTD devices, it may be permissible to control operations of the plurality of TTD devices 120 in compensating or adjusting time delays for the plurality of antennas to the photonic signals of the plurality of channels.

As described above, the photonic beam forming network chip 100 may prevent an unwanted photonic coupling effect between the plurality of MZM 110 and the plurality of TTD devices 120 by adjusting center operating wavelengths of the photonic waveguides 151 and 152, which are included respectively in the plurality of MZM 110 and the plurality of TTD devices 120, through an electro-optical effect or the ring resonator 153.

Additionally, although not shown, since the photonic waveguides 151 and 152 included respectively in the plurality of MZM 110 and the plurality of TTD devices 120 are formed with metal heaters for adjusting their center operating wavelengths through a thermo-optical effect, the photonic beam forming network chip 100 may adjust center operating wavelengths of the photonic waveguides 151 and 152, which are included respectively in the plurality of MZM 110 and the plurality of TTD devices 120, through an electro-optical effect or the ring resonator 153.

The at least one power splitter 130 may split optical power, which is generated from the photonic source 160, into equivalents. For example, since the at least one power splitter 130 may be disposed between the photonic source 160 and the plurality of MZM 110 in the photonic beam forming network chip 100 and may split optical power, which is generated from the photonic source 160, into equivalents in several times, it may allow the plurality of MZM 110 to change the plurality of RF signals into the photonic signals of the plurality of channels in accordance with the split equivalents of the optical power.

At least one power combiner 170 further included in the photonic beam forming network chip 100 may couple the photonic signals of the plurality of channels. For example, first power combiners 171 disposed between the plurality of MZM 110 and the plurality of TTD devices 120 in the photonic beam forming network chip 100 may couple a photonic signal of a first channel, which is output from a first MZM 111, with a photonic signal of a second channel which is output from a second MZM 112, and may transmit the coupled photonic signal to a first TTD device 121. The first power combiners 171 may couple a photonic signal of a third channel, which is output from a third MZM 113, with a photonic signal of a fourth channel which is output from a fourth MZM 114, and then may transmit the coupled photonic signal to a second TTD device 122.

As also, a second power combiner 172 disposed between the plurality of TTD devices 120 and the photonic detector 140 may couple a photonic signal, which is output from a first TTD device 121, with a photonic signal which is output from a second TTD device 122, and then may transmit the coupled photonic signal to the photonic detector 140.

These at least one power splitter 130 and at least one power combiner 170 may be formed based on Multi-Mode Interferometer (MMI) and may be formed to have a photonic coupling loss value and a photonic split loss value that are respectively equal to or lower than specific values. Additionally, the numbers of the power splitters 130 and the power combiners 170 may be adaptively adjusted in accordance with the numbers of the plurality of MZM 110 and the plurality of TTD devices 120.

The photonic detector 140 may change a single photonic signal, which is made by coupling a plurality of photonic signals, into a single RF signal. for example, the photonic detector 140 may receive a single photonic signal, which is made by coupling a photonic signal of the first TTD device 121 with a photonic signal of the second TTD device 122, and may change the single photonic signal into a single RF signal.

However, embodiments of the inventive concept may not be restrictive hereto. For example, in the case that the photonic beam forming network chip 100 does not include at least one power combiner 170 (or the case that the photonic beam forming network chip 100 includes only the first power combiner 171 among the power combiners 170), the photonic detector may change the photonic signals of the plurality of channels, which are output from the plurality of TTD devices 120, into their respective RF signals.

During this, a plurality of hybrid photonic amplifiers 180, a plurality of photonic attenuators 181, and a plurality of phase tuners 183 may be further disposed between the plurality of TTD devices 120 and the photonic detector 140.

The plurality of hybrid photonic amplifiers 180 may amplify the photonic signals of the plurality of channels which are output from the plurality of TTD devices 120.

Each of the plurality of photonic attenuators 181 may be formed by attaching a p-i-n diode to a photonic waveguide 154. The plurality of photonic attenuators 181 may adjust each photonic loss of the plurality of photonic attenuators to the photonic signals of the plurality of channels which are output from the plurality of TTD devices 120. Thereby, it may be permissible to tune photonic loss of the plurality of TTD devices 120 in a specific range.

Each of the plurality of phase tuners 183 may be formed by attaching a metal heater (e.g., a metal heater made of TiN) to a photonic waveguide 155. The plurality of phase tuners 183 may synchronize phase changes due to free carrier injection.

As described above, since the photonic beam forming network chip 100 has a structure in which the photonic waveguide 150 connects elements one another, it may be allowable to fabricate the elements of the chip on the structure based on the photonic waveguide 150 after forming the photonic waveguide 150 through a Si-photonic process for a basic device in which silicon is stacked on SiO2 box.

The aforementioned embodiments are described about the photonic beam forming network chip 100 in the case of receiving a plurality of RF signals from a plurality of RF signals. A photonic beam forming network chip may be otherwise formed in the same structure even in the case of transmitting a plurality of RF signals to a plurality of antennas, but the feature of which will be further described later.

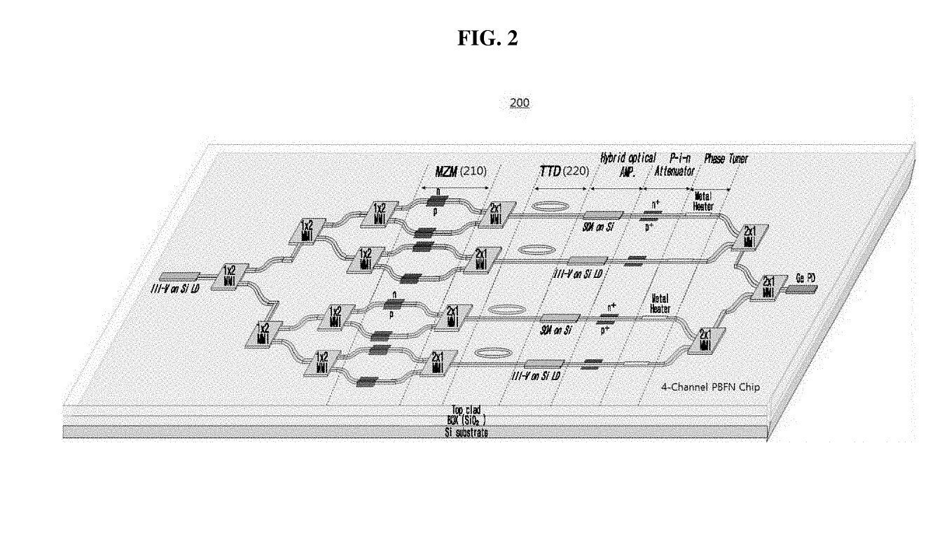

Additionally, although the photonic beam forming network chip 100 according to an embodiment is described as being implemented in a form of two channels, embodiments of the inventive concept may provide a photonic beam forming network chip with four channels. This embodied configuration will be described in conjunction with FIG. 2.

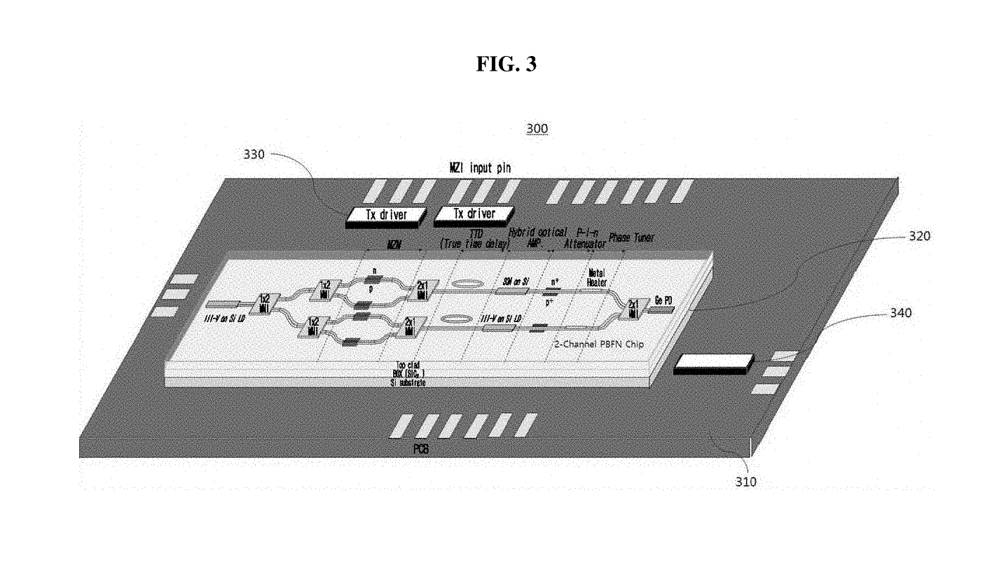

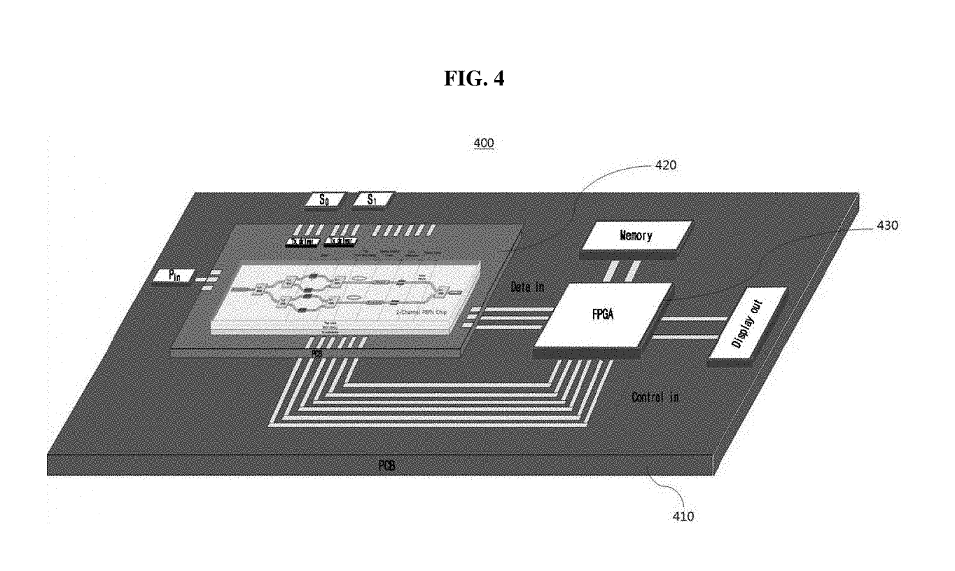

Additionally, it may be allowable to form a photonic beam forming network chip package and a photonic beam forming network system, based on the photonic beam forming network chip 100 according to an embodiment. These embodied configurations will be described in conjunction with FIGS. 3 and 4.

FIG. 2 is a diagram illustrating a photonic beam forming network chip according to another embodiment.

Referring to FIG. 2, a photonic beam forming network chip 200 according to another embodiment is similar to the photonic beam forming network chip described with reference to FIG. 1, in structures and operations of elements thereof, but different from the numbers of a plurality of MZM 210, a plurality of TTD devices 220, and power splitters.

For example, the photonic beam forming network chip 200 according to another embodiment may have a structure in which the photonic beam forming network chip of FIG. 1 is provided in two members.

Accordingly, the photonic beam forming network chip 200 may be implemented diversely or extensively in various forms of N channels by adaptively adjusting the numbers of elements thereof.

FIG. 3 is a diagram illustrating a photonic beam forming network package according to an embodiment.

Referring to FIG. 3, a photonic beam forming network package 300 according to an embodiment may include a photonic beam forming network chip 320, a transmission (Tx) module 330, and a reception (Rx) module 340 which are all integrated on a Printed Circuit Board (PCB) 310.

In this configuration, the photonic beam forming network chip 320, as the photonic beam forming network chip illustrated in FIG. 1, may be formed to have the structure described in conjunction with FIG. 1. Embodiments of the inventive concept however may not be restrictive or defined hereto and rather may be variously structured in extended forms with N channels as shown in FIG. 2.

The Tx module 330 and the Rx module 340 may function as drivers for controlling the photonic beam forming network chip 320. For example, the Tx module 330 may support a G-S-G-S-G type device with a differential signal in the configuration that has an operable speed equal to or higher than 1 Gbps (or 5 Gbps), an operating voltage equal to or lower than 5 V (or 4 V), and channel members equal to or more than 4 channels (or 8 channels), and thereby may control a plurality of MZM included in the photonic beam forming network chip 320. The Rx module 340 may be configured to have an operable speed equal to or higher than 10 Gbps and thereby may control a photonic detector included in the photonic beam forming network chip 320.

FIG. 4 is a diagram illustrating a photonic beam forming network system according to an embodiment.

Referring to FIG. 4, a photonic beam forming network system 400 according to an embodiment may include a photonic beam forming network package 420 and a Field Programmable Gate Array (FPGA) 430 which are all integrated on a PCB 410.

In this configuration, the photonic beam forming network package 420, as the photonic beam forming network package illustrated in FIG. 3, may be a photonic beam forming network package including a photonic beam forming network chip structured as described in conjunction with FIG. 1. Embodiments of the inventive concept however may not be restrictive or defined hereto and rather may be variously structured in extended forms with N channels as shown in FIG. 2.

The FPGA 430, as a circuit for controlling the photonic beam forming network package 420, especially, may be a circuit including a logic circuit which is programmed to drive a photonic beam forming network chip included in the photonic beam forming network chip 420. For example, the FPGA 430 may be a circuit for adjusting a beam steering angle and controlling a beam tracking error by driving a photonic beam forming network chip.

Embodiments of the inventive concept may provide a photonic beam forming network chip suitable for preventing a photonic coupling effect between an InP-compound semiconductor based MZM and an Si3N4 photonic waveguide based TTD which is equipped in an existing OBFN, using silicon photonics technology.

In detail, embodiments of the inventive concepts may provide a photonic beam forming network chip connected based on a photonic waveguide without any coupling effect between a plurality of MZM and a plurality of TTD devices by fabricating at least one power splitter to split optical power, which is generated from one photonic source, into equivalents, a plurality of MZM using the at least one power splitter to change a plurality of RF signals into photonic signals of a plurality of channels, and a plurality of TTD devices to compensate or adjust time delays for a plurality of antennas to the photonic signals of the plurality of channels based on a ring resonator, on a single chip.

Additionally, embodiments of the inventive concept may provide a photonic beam forming network chip configuring a photonic waveguide, which has a photonic waveguide loss value equal to or lower than a specific reference value, to minimize photonic loss differences between photonic signals of a plurality of channels that are changed from a plurality of RF signals.

Additionally, embodiments of the inventive concept may provide a photonic beam forming network package and a photonic beam forming network system that are based on a photonic beam forming network chip.

As described above, while the inventive concept has been described with reference to exemplary embodiments, it will be apparent to those skilled in the art that various changes and modifications may be made from the above description. For example, it may be allowable to achieve desired results although the embodiments of the inventive concept are performed in other sequences different from the descriptions, and/or the elements, such as system, structure, device, circuit, and so on, are combined or assembled in other ways different from the descriptions, replaced or substituted with other elements or their equivalents.

Therefore, other implementations, embodiments, and equivalents of the annexed claims may be construed as being included in the annexed claims as follows.

What is claimed is:

1. A photonic beam forming network chip using silicon semiconductor based monolithic integration for fabrication and using true time delay for signal processing of a phased array antenna, comprising:
at least one power splitter configured to split optical power, which is generated from a photonic source, in equivalents;
a plurality of Mach-Zehnder modulators configured to change a plurality of RF signals, which are transmitted to or received from a plurality of antennas, into photonic signals of a plurality of channels by using the at least one power splitter;
a plurality of true time delay devices configured to compensate or adjust time delays for the plurality of antennas to the photonic signals of the plurality of channels;
at least one power combiner configured to combine optical power, which is propagated from a plurality of true time delay devices;
a photonic detector configured to change a single photonic signal that is formed by coupling the photonic signals of the plurality of channels, or the photonic signals of the plurality of channels, into an RF signal; and
a photonic waveguide configured to respectively connect the at least one power splitter, the plurality of Mach-Zehnder modulators, the plurality of true time delay devices, the at least one power combiner and the photonic detector.

2. The photonic beam forming network chip of claim 1, wherein the number of the plurality of Mach-Zehnder modulators is determined based on the number of the plurality of antennas.

3. The photonic beam forming network chip of claim 1, wherein each of the plurality of true time delay devices is formed by providing a ring resonator in the photonic waveguide and is configured to compensate or adjust time delays for the plurality of antennas in accordance with an operation of the ring resonator.

4. The photonic beam forming network chip of claim 1, wherein the photonic waveguide is configured to have a photonic waveguide loss value equal to or lower than a reference value to minimize photonic loss differences between the photonic signals of the plurality of channels.

5. The photonic beam forming network chip of claim 1, further comprising a plurality of photonic attenuators configured to tune photonic loss of the plurality of true time delay devices in a range.

6. The photonic beam forming network chip of claim 5, wherein each of the plurality of photonic attenuators is formed by attaching a p-i-n diode to the photonic waveguide.

7. The photonic beam forming network chip of claim 5, further comprising a plurality of phase tuners configured to synchronize phase change through free carrier injection in the plurality of photonic attenuators.

8. The photonic beam forming network chip of claim 7, wherein each of the plurality of phase tuners is configured by attaching a metal heater to the photonic waveguide.

9. The photonic beam forming network chip of claim 1, wherein the photonic waveguide included in each of the plurality of Mach-Zehnder modulators and the plurality of the true time delay devices comprises a metal heater configured to adjust a center operating wavelength through a thermo-optical effect.

10. The photonic beam forming network chip of claim 1, further comprising a plurality of hybrid photonic amplifiers configured to amplify the photonic signals of the plurality of channels.

11. The photonic beam forming network chip of claim 1, further comprising at least one power combiner configured to couple the photonic signals of the plurality of channels.

12. A photonic beam forming network package using silicon semiconductor based monolithic integration for fabrication and using true time delay for signal processing of a phased array antenna, comprising:
a photonic beam forming network chip; and
a transmission module and a reception module that control the photonic beam forming network chip,
wherein the photonic beam forming network chip comprises:
at least one power splitter configured to split optical power, which is generated from a photonic source, in equivalents;
a plurality of Mach-Zehnder modulators configured to change a plurality of RF signals, which are transmitted to or received from a plurality of antennas, into photonic signals of a plurality of channels by using the at least one power splitter;
a plurality of true time delay devices configured to compensate or adjust time delays for the plurality of antennas to the photonic signals of the plurality of channels;
a photonic detector configured to change a single photonic signal that is formed by coupling the photonic signals of the plurality of channels, or the photonic signals of the plurality of channels, into an RF signal; and
a photonic waveguide configured to respectively connect the at least one power splitter, the plurality of Mach-Zehnder modulators, the plurality of true time delay devices, and the photonic detector.

13. A photonic beam forming network system using silicon semiconductor based monolithic integration for fabrication and using true time delay for signal processing of a phased array antenna, comprising:
a photonic beam forming network package; and
a field programmable gate array configured to control the photonic beam forming network package,
wherein the photonic beam forming network package comprises:
at least one power splitter configured to split optical power, which is generated from a photonic source, in equivalents;
a plurality of Mach-Zehnder modulators configured to change a plurality of RF signals, which are transmitted to or received from a plurality of antennas, into photonic signals of a plurality of channels by using the at least one power splitter;
a plurality of true time delay devices configured to compensate or adjust time delays for the plurality of antennas to the photonic signals of the plurality of channels;
a photonic detector configured to change a single photonic signal that is formed by coupling the photonic signals of the plurality of channels, or the photonic signals of the plurality of channels, into an RF signal;
a photonic waveguide configured to respectively connect the at least one power splitter, the plurality of Mach-Zehnder modulators, the plurality of true time delay devices, the at least one power combiner, and the photonic detector; and
a transmission module and a reception module that control the plurality of Mach-Zehnder modulators.
